(19) United States
(12) Patent Application Publication
(10) Pub. No.: US 2011/0193827 A1
(43) Pub. Date: Aug. 11, 2011

(54) STYLUS

(75) Inventor: SHI-XU LIANG, Shenzhen (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/840,435

(22) Filed: Jul. 21, 2010

(30) Foreign Application Priority Data
Feb. 8, 2010 (CN) 201010301359.4

(51) Int. Cl. G06F 3/033

(52) U.S. Cl. 345/179

(57) ABSTRACT

A stylus comprises a housing has a receptacle defined therethrough, a tip body slidably accommodated in the receptacle, a slide enabling member and a cap assembly. The tip body includes a body. The slide enabling member includes the body of the tip body and a guiding hole slidably engaging with the body, the guiding hole is defined in the housing, when the tip body is accommodated in the receptacle, the body passes through the guiding hole. The cap assembly is releasably latched to the tip body and the housing. The latching force between the tip body and the cap assembly is larger than a latching force between the cap assembly and the housing, so when an external force is exerted on the cap assembly to remove the cap assembly away from the tip body, the cap assembly is separated from the housing but the cap assembly is firmly latched on the tip body.

### BACKGROUND

1. Technical Field

This exemplary disclosure generally relates to retractable/extendable styluses.

2. Description of Related Art

A variety of devices include a touch screen. Examples of such devices include smart phones, personal digital assistants (PDA), pagers, personal organizers, and the like. These devices typically include a display module under the touch screen. The display module generates target images associated with menu options, programs, user choices, and other operations. The user controls the device by pressing the touch screen over the target image with a stylus. However, typical styluses often have no effective cap for protecting their stylus tip.

Therefore, there is room for improvement within the art

### BRIEF DESCRIPTION OF THE DRAWINGS

Many aspects of the exemplary stylus can be better understood with reference to the following drawings. The components in the various drawings are not necessarily drawn to scale, the emphasis instead being placed upon clearly illustrating the principles of the exemplary stylus. Moreover, in the drawings, like reference numerals designate corresponding parts throughout the diagrams.

FIG. 1 is an exploded view of an exemplary stylus.

FIG. 2 is an assembled view of the stylus shown in FIG. 1.

FIG. 3 is similar to FIG. 2, but showing the stylus in an extended configuration.

FIG. 4 is similar to FIG. 3, but a cap assembly is removed.

FIG. 5 is a cross-sectional view of the stylus shown in FIG. 2 along the line V-V.

FIG. 6 is a cross-sectional view of the stylus shown in FIG. 3 along the line VI-VI.

FIG. 7 is a cross-sectional view of the stylus shown in FIG. 4 along the line VII-VII.

### DETAILED DESCRIPTION

In this exemplary embodiment, the stylus is used to contact a touch screen display of an electronic device such as a mobile telephone. The mobile telephone described herein is a representation of the type of wireless communication device that may benefit from the exemplary embodiment. However, it is to be understood that the exemplary embodiment may be applied to any type of hand-held or portable electronic device including, but not limited to, the following devices: radiotelephones, cordless phones, paging devices, personal digital assistants, portable computers, pen-based or keyboard-based handheld devices, remote control units, portable media players (such as an MP3 or DVD player) that have wireless communication capability and the like. Accordingly, any reference herein to the mobile telephone should also be considered to apply equally to other portable wireless electronic devices.

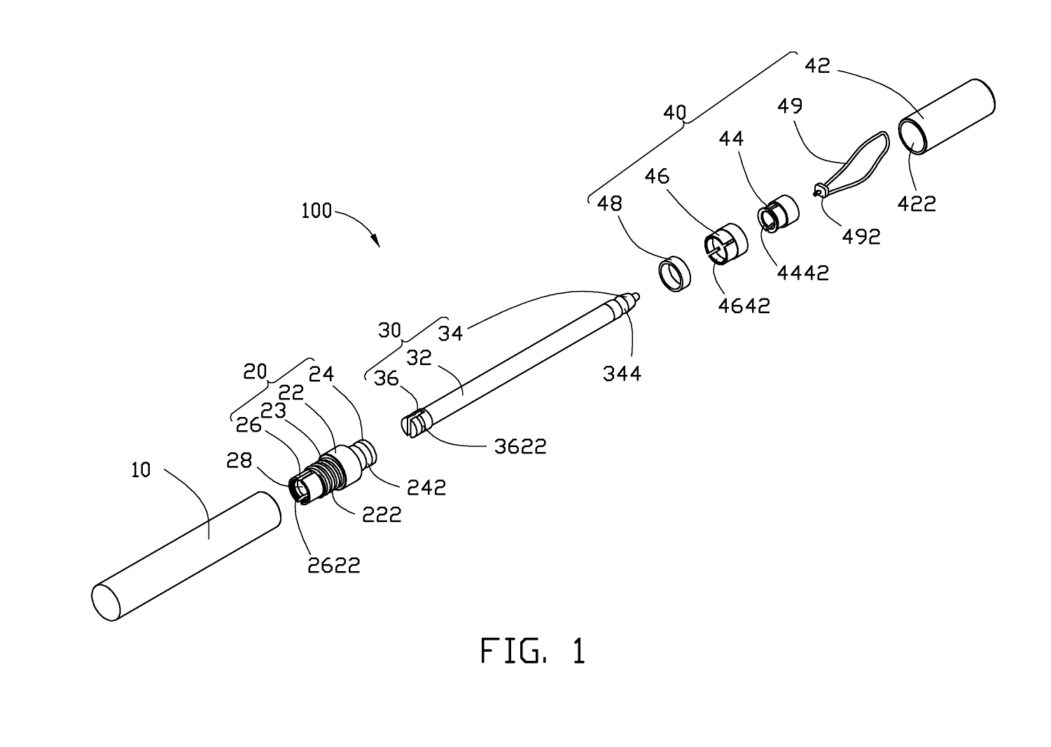

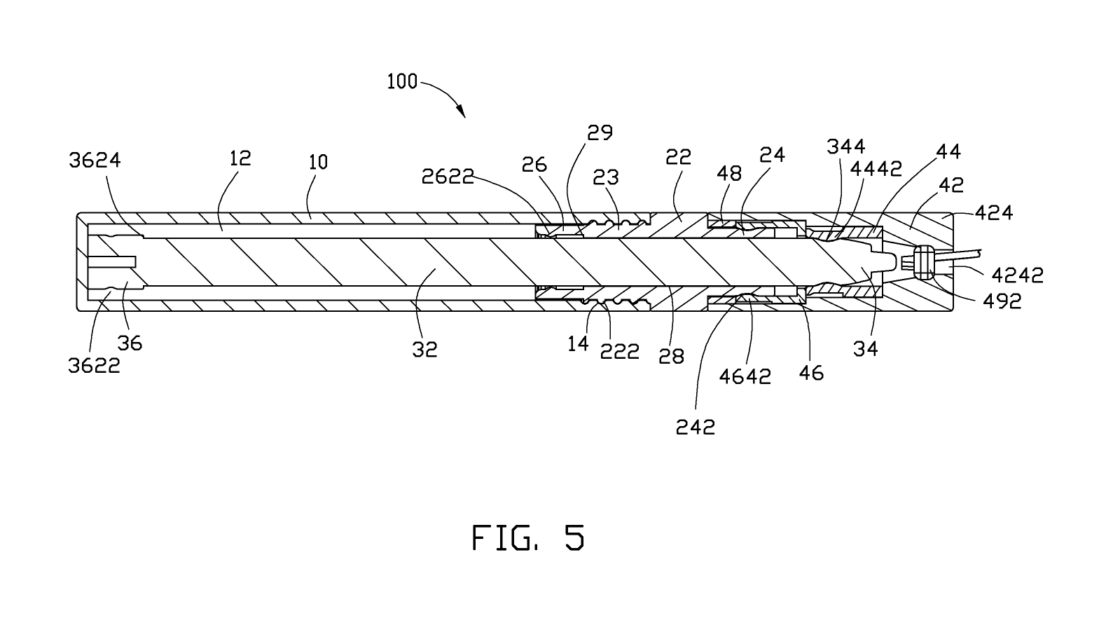

Referring to FIGS. 1 and 5, a stylus 100 includes a housing 10, a tip body 30 and a cap assembly 40. The tip body 30 is retractably accommodated in the housing 10 by a slide enabling member (not labeled), and the cap assembly 40 covers and protects a distal portion of the tip body 30, including the tip head 34.

The housing 10 is tubular and of any suitable manufacture, and may for example be constructed of a light weight metal such as stainless steel or aluminum alloy. The housing 10 is hollow, having a receptacle 12 defined longitudinally therethrough.

The tip body 30 be of any suitable manufacture, and may for example be constructed of a lightweight metal such as stainless steel or aluminum alloy. The tip body 30 is received within the receptacle 12 of the housing 10 and partially extends out of the housing 10. The tip body 30, in this exemplary embodiment, may include a body 32, a tip head 34 which protrudes from one end of the body 32, and a body end 36 which protrudes from another end of the body 32.

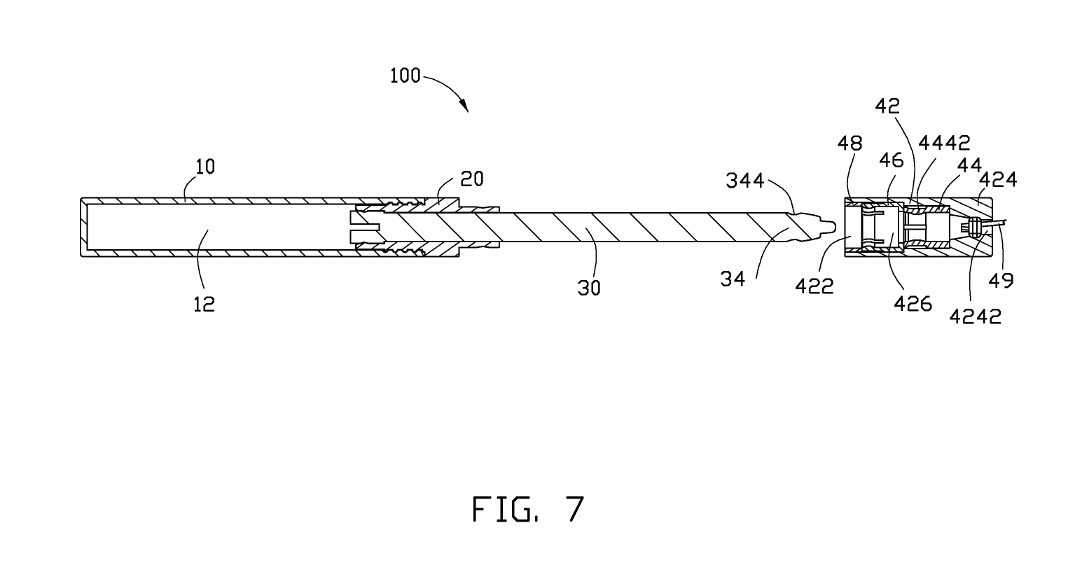

Referring to FIGS. 1, and 7, the cap assembly 40 includes a hollow cap 42 with an opening 422 formed at one end thereof and a flange 424 protruding from an inner wall of another end thereof, and a chamber 426 defined between the opening 422 and the flange 424. The cap assembly 40 further includes a rope 49, a bushing 44, a sleeve 46 and a positioning ring 48 retained in the chamber 426. The flange 424 has an orifice 4242 defined therethrough, the rope 49 extends out of the flange 424 via the orifice 4242, and a node 492, such as a knot, formed on the rope 49, is larger than the orifice 4242 so the node 492 can prevent the rope 49 and the cap 42 from separating.

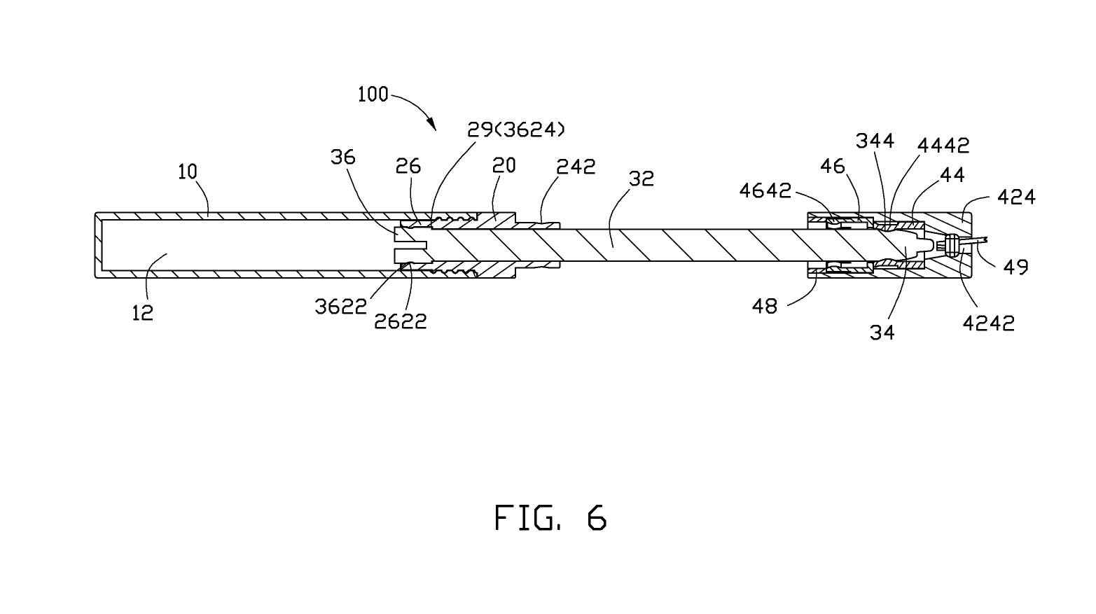

Referring to FIGS. 1, 5 and 6, the slide enabling member is for enabling the tip body 30 to slidably engage in the housing 10 from a closed/retracted configuration shown in FIG. 5 to an extended configuration shown in FIG. 6. The slide enabling member, in this exemplary embodiment, may include the body 32 and a guiding hole 28 that engages the body 32. The guiding hole 28 is defined through a guiding element 20 that is located in the receptacle 12 of the housing 10. When the tip body 30 is received in the receptacle 12, the body 32 passes through the guiding hole 28. The body 32 has the same shape as, but slightly smaller than, the guiding hole 28, so the body 32 can be slidably (friction) fitted in the guiding hole 28.

The guiding element 20, in this exemplary embodiment, includes a resisting portion 22, a retaining portion 23 extending from one end of the resisting portion 22, a latching portion 24 extending from another end of the resisting portion 22, and a securing portion 26 extending from a distal end of the retaining portion 23. Referring to FIG. 5, the retaining portion 23 may be retained on the housing 10 in such a way that a thread 222 is positioned on the retaining portion 23 and a threaded groove 14 is defined in an inner surface of the housing 10, the thread 222 engages with the threaded groove 14 so the guiding element 20 is retained on the housing 10.

Referring to FIGS. 5 and 6, the sliding enabling member further includes a first stopping member (not labeled) which is for holding the tip body 30 in the retracted configuration, and a second stopping member (not labeled) which is for holding the tip body 30 in the extended configuration. The first stopping member, in this exemplary embodiment, includes a latching slot 242 and a rib 4642 that engages in the latching slot 242. The latching slot 242 is defined in the latching portion 24 of the guiding element 20 and the rib 4642 is positioned on the sleeve 46. The latching slot 242 is sized and dimensioned to tightly fit the rib 4642 therein when the tip body 30 slides to the retracted configuration. The second stopping member, in this exemplary embodiment, includes a securing slot 3622 and a block 2622 that engages in the securing slot 3622. The securing slot 3622 is defined in the body end 36 and the block 2622 protrudes from in an inner surface of the securing portion 26. The securing slot 3622 is sized and dimensioned to tightly fit the block 2622 therein when the tip body 30 slides to the extended configuration. Thus, the tip body 30 can be firmly held in the retracted configuration by the tight fit engagement between the latching slot 242 and rib 4642, and can be firmly held in the extended configuration by the tight fit engagement between the securing slot 3622 and block 2622.

A retaining structure is illustrated in FIGS. 1 and 5. The retaining structure is for retaining the cap assembly 40 to the tip body 30. The retaining structure, in this exemplary embodiment, may include a retaining slot 344 and a protrusion 4442 that engages in the retaining slot 344. The retaining slot 344 is defined in the tip body 30 and located between the tip head 34 and the body 32. The protrusion 4442 is positioned on the bushing 44. The protrusion 4442 is rested in the retaining slot 344 when the cap 42 covers the tip head 34, firmly holding the cap 42 on the tip head 34 to protect the tip head 34. In this exemplary embodiment, the latching force between the protrusion 4442 and the retaining slot 344 is larger than the latching force between the rib 4642 and the latching slot 242, so when an external force is exerted on the cap 42 to remove the cap 42 from the tip body 30, the rib 4642 is slid out of the latching slot 242 with the cap 42 firmly latched on the tip head 34 of the tip body 30, and then causing the body 32 to slide relative to the housing 10. Referring to FIG. 6, the latching force between the protrusion 4442 and the retaining slot 344 is also larger than the latching force between the block 2622 and the securing slot 3622, so when an external force is exerted on the cap 42 to drive the tip body 30 to retract in the housing 10, the block 2622 would be slid out of the securing hole 522, but the protrusion 4442 is firmly latched in the retaining slot 344, thus causing the body 32 to slide relative to the housing 10 until the body 32 is located in the retracted configuration.

Referring to FIGS. 5 and 6, a third stopping member (not labeled) is formed between the tip body 30 and the guiding element 20. The third stopping member assists the tip body 30 to be retained in the extended configuration. The third stopping member includes a first shoulder 29 and a second shoulder 3624 that resists the first shoulder 29 when the tip body 30 is located in the extended configuration. The first shoulder 29 is positioned on the guiding element 20 and the second shoulder 3624 is positioned on the body end 36. When an external force is exerted on the cap 42 to remove the cap 42 from the tip body 30, the first shoulder 29 resists against the second shoulder 3624 to prevent the tip body 30 and the housing 10 from separating.

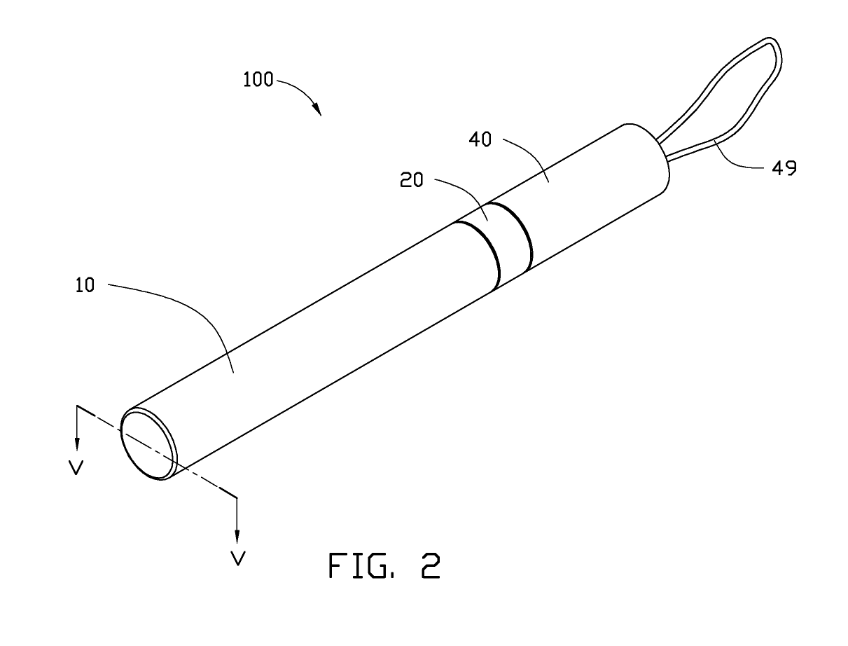

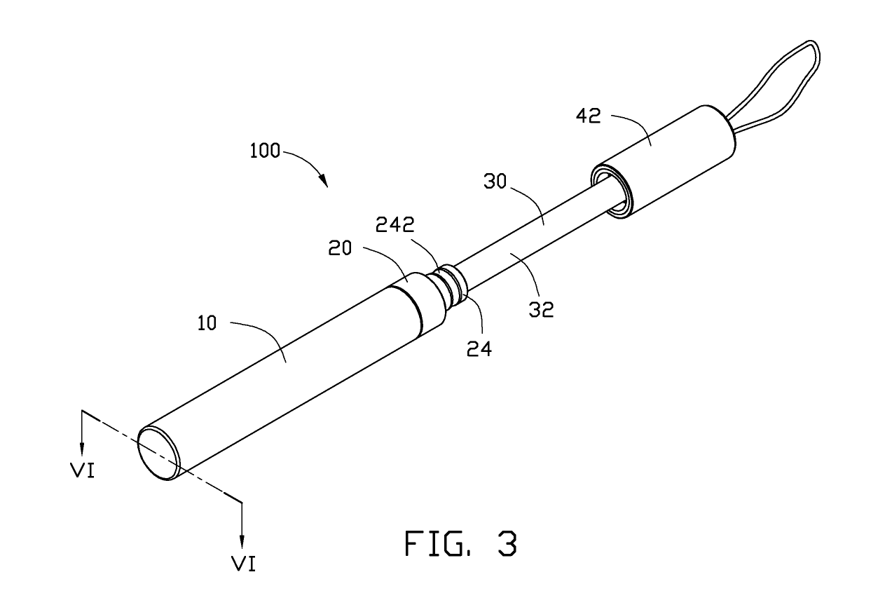

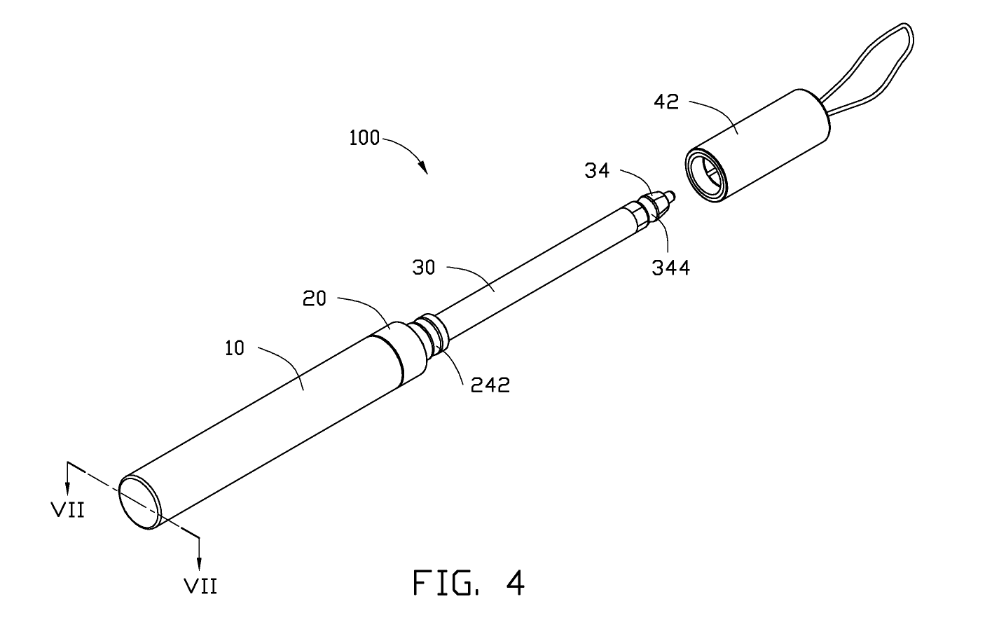

Referring to FIGS. 1-5, to assemble the stylus 100, the tip body 30 is inserted in the receptacle 12 of the housing 10. The thread 222 is threaded in the threaded groove 14 so the guiding element 20 is mounted to the housing 10, the body 32 is accommodated in the guiding hole 28. The rope 49, the bushing 44, the sleeve 46, and the positioning ring 48 are assembled into the cap 42 in turn, so an assembled cap assembly 40 is yielded. The cap assembly 40 is cover on the tip head 34 of the tip body 30 with the protrusion 4442 accommodated in the retaining slot 344 and the rib 4642 latched in the latching slot 242, to complete assembly of the stylus 100.

Referring to FIGS. 5-7, in operation, the rope 49 of the cap assembly 40 is removed from the housing 10 under an external force, until the rib 4642 is slid out of the latching slot 242. The body 32 slides in the guiding hole 28 of the guiding element 20 from the retracted configuration shown in FIG. 5 to the extended configuration shown in FIG. 6. Once the block 2622 is accommodated in the securing slot 3622, the tip body 30 is firmly positioned in the extended configuration (FIG. 6). Continuing to drag the rope 49, the protrusion 4442 is slid out of the retaining slot 344 until the cap assembly 40 is removed from the tip body 30, and the first shoulder 29 resists the second shoulder 3624 to prevent the tip body 30 and the housing 10 from separating.

It is to be further understood that even though numerous characteristics and advantages of the exemplary embodiments have been set forth in the foregoing description, together with details of structures and functions of various embodiments, the disclosure is illustrative only, and changes may be made in detail, especially in matters of shape, size, and arrangement of parts within the principles of the exemplary invention to the full extent indicated by the broad general meaning of the terms in which the appended claims are expressed.

What is claimed is:

1. A stylus, comprising:
a housing having a receptacle defined therethrough;
a tip body slidably accommodated in the receptacle of the housing, wherein the tip body includes a body;
a slide enabling member for enabling the tip body to slidably engage in the housing from a retracted configuration to an extended configuration, wherein the slide enabling member includes the body of the tip body and a guiding hole defined in the housing and slidably engaging with the body; and
a cap assembly releasably latched to the tip body and the housing;
wherein a latching force between the tip body and the cap assembly is larger than a latching force between the cap assembly and the housing, so the cap assembly is capable of being separated from the housing but the cap assembly is firmly latched on the tip body with an exertion of an external force on the cap assembly to move the cap assembly relative to the tip body.

2. The stylus as claimed in claim 1, wherein the stylus further comprise a guiding element located in the receptacle of the housing, the guiding hole is defined through the guiding element.

3. The stylus as claimed in claim 2, wherein the guiding element includes a retaining portion, a thread is positioned on the retaining portion, a threaded groove is defined in an inner surface of the housing; the thread engages with the threaded groove so the guiding element is retained on the housing.

4. The stylus as claimed in claim 1, wherein the sliding enabling member further includes a first stopping member formed between the tip body and the housing; the first stopping member is for holding the tip body in a retracted configuration.

5. The stylus as claimed in claim 4, wherein the first stopping member includes a latching slot and a rib that engages the latching slot, the latching slot is defined in the housing and the rib is positioned on the cap assembly.

6. The stylus as claimed in claim 4, wherein the stylus further includes a retaining structure formed between the cap assembly and the tip body; the retaining structure is for retaining the cap assembly to the tip body.

7. The stylus as claimed in claim 6, wherein the retaining structure includes a retaining slot and a protrusion that engages in the retaining slot.

8. The stylus as claimed in claim 7, wherein the retaining slot is defined in the tip body, the protrusion is positioned on the cap assembly, the protrusion is rested in the retaining slot to latch the cap assembly to the tip body.

9. The stylus as claimed in claim 7, wherein the latching force between the protrusion and the retaining slot is larger than the latching force between the rib and the latching slot.

10. The stylus as claimed in claim 9, wherein the slide enabling member further includes a second stopping member formed between the tip body and the housing; the second stopping member is for holding the tip body in the extended configuration.

11. The stylus as claimed in claim 10, wherein the second stopping member includes a securing slot and a block that engages the securing slot, the block is latched in the securing slot to hold the tip body in the extended configuration.

12. The stylus as claimed in claim 11, wherein the securing slot is defined in the tip body and the block protrudes from housing.

13. The stylus as claimed in claim 11, wherein the latching force between the protrusion and the retaining slot is larger than the latching force between the block and the securing slot.

14. The stylus as claimed in claim 13, wherein a third stopping member is formed between the tip body and the housing, the third stopping member assists the tip body to be retained in the extended configuration.

15. The stylus as claimed in claim 14, wherein the third stopping member includes a first shoulder and a second shoulder that resists the first shoulder when the tip body is located in the extended configuration.

16. The stylus as claimed in claim 15, wherein the first shoulder is positioned on the guiding element and the second shoulder is positioned on the tip body.

17. A stylus, comprising:
a housing having a receptacle defined therethrough;
a tip body retractably accommodated in the receptacle of the housing and being capable of sliding from a retracted configuration to an extended configuration;
a guiding element mounted to the housing; and
a cap assembly releasably latched to the tip body and the guiding element;
wherein the cap assembly along with the tip body slides relative to the housing with an exertion of an outer force on the cap assembly from the retracted configuration to the extended configuration in which the tip body latches with the guiding element to prevent the tip body separating from the housing.

18. The stylus as claimed in claim 17, wherein the stylus further comprise a slide enabling member configured for enabling the tip body slidably coupled to the housing, the tip body include a body; the slide enabling member includes the body and a guiding hole slidably engaging with the body, the guiding hole is defined through the guiding element.

19. The stylus as claimed in claim 18, wherein when the tip body is in the retracted configuration, a latching force between the cap assembly and the guiding element is smaller than a latching force between the cap assembly and the tip body; when the tip body is in the extended configuration, a latching force between the tip body and the guiding element is smaller than the latching force between the cap assembly and the tip body.
